(19) United States
(12) Patent Application Publication
(10) Pub. No.: US 2009/0119710 A1
(43) Pub. Date: May 7, 2009

(54) METHOD AND APPARATUS FOR ENHANCING SUPPORT FOR USER-GENERATED CONTENT DELIVERY

(75) Inventors: Charles N. Lo, San Diego, CA (US); James D. Coyer, Encinitas, CA (US); Prasanna Kannan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/261,850

(22) Filed: Oct. 30, 2008

Related U.S. Application Data
(60) Provisional application No. 60/984,568, filed on Nov. 1, 2007.

(51) Int. Cl. H04N 5/445

(52) U.S. Cl. 725/39

(57) ABSTRACT

A user-generated content (UGC) mobile distribution system supports creation of a personalized and virtual UGC broadcast channel that can be selectively clipped and cached by filtering based inter alia on content descriptors of popularity and freshness. A broadcast service provider can further provide meta data categorization for filtering that is more objective than what is supplied by a posting user of UGC content items. A broadcast program guide enables mobile devices to schedule clip downloads. Popularity, which can be sorted by applicable demographic, represents a criterion (e.g., rating scores, number of views, quantity of online discussion, etc.) whether associated content item should be downloaded for subsequent accessibility by a user, enhancing filtering based upon user profile and genre. Freshness represents how recent the associated content was made available for download by the broadcast service provider. Popularity can also be used as weighting to sort a display of cached content items.

### CLAIM OF PRIORITY UNDER 35 U.S.C. §119

The present Application for Patent claims priority to Provisional Application No. 60/984,568 entitled “METHOD AND APPARATUS FOR ENHANCING SUPPORT FOR USER-GENERATED CONTENT DELIVERY” filed 01-Nov.-2007, and assigned to the assignee hereof and hereby expressly incorporated by reference herein.

### BACKGROUND

Second generation (2G) networks include Code Division Multiple Access (CDMA) and Global System for Mobile Communications (GSM) networks and provide a wireless connection for digital voice encoding. Third Generation (3G) mobile networks offer cellular data rates that approach a wired broadband connection. These 3G mobile networks are robust delivery mechanisms for a rich variety of services that are being offered around the world. From CDMA 2000-based networks to those based on WCDMA (Wide-band Code-Division Multiple Access), cellular users are able to access services and information that were once only available from a wired desktop computer. Using third generation technologies it is now possible to deliver applications and multimedia services, such as streaming video files and interactive television programming, to these mobile devices.

WCDMA is also referred to as Universal Mobile Telecommunications System (UMTS) and along with CDMA 2000 represent an evolution in terms of services and data speeds from todays 2G mobile networks. UMTS and CDMA 2000 third generation mobile technologies identified by the ITU (International Telecommunication Union) are expected to include capabilities and features such as: enhanced multimedia (voice, data, video, and remote control), usability on all popular modes (cellular telephone, e-mail, paging, fax, videoconferencing, and Web browsing), broad bandwidth and high speed (upwards of 2 Mbps) routing flexibility (repeater, satellite, LAN), operation at approximately 2 GHz frequencies, and roaming capability throughout Europe, Japan, and North America.

Today's mobile customers have already demonstrated a desire for “non-voice” and other new services. More than 24 billion text messages are sent every month, and now customers are choosing Multimedia Messaging Service (MMS), an evolution of text messaging that adds pictures and sound elements. CDMA 2000 and UMTS build on these first steps towards a mobile multimedia future, allowing operators to offer new services to consumers. The availability of these robust mobile networks and sophisticated handheld devices, coupled with increasing consumer demand for media content, has generated a need for improved methods of subscribing to multimedia programming and packaged content at a mobile device.

Limitations on Over-the-Air (OTA) resources and of available power and storage for mobile devices make unicast of content challenging for mobile devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with providing broadcast of content item to a population of mobile devices that are selectively stored and presented as a channel to mimic a unicast or multicast user experience. A mobile operator can characterize such content items to enable mobile devices to selectively receive and cache content of interest to a user. Thereby, individualized content can be efficiently distributed and used.

Apparatus and methods are presented for processing user-generated content. In such apparatus and method, at least one characteristic is received for each of a plurality of user-generated content items to be broadcast by a mobile operator, the at least one characteristic generated by the mobile operator and pertaining to an objective measure of current user interest in the corresponding user-generated content. At least one user-generated content item is selected based upon at least one characteristic. At least one selected user-generated content item is stored as the plurality of user-generated-content items are broadcast.

Apparatus and methods are presented for broadcasting user-generated content. In such apparatus and methods, at least one characteristic is assigned to each of a plurality of user-generated content items, the at least one characteristic pertaining to an objective measure of current user interest in the user-generated content item. Thereafter, the assigned characteristic and the content item are broadcast to mobile devices.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 depicts a block diagram of a system for personalized wireless dissemination of user-generated content (UGC) operating across a communication network;

FIG. 2 depicts a timing diagram of a methodology for personalized wireless dissemination of user-generated content (UGC) performed between a communication network of a mobile device and a mobile broadcast delivery service;

FIG. 3 depicts a block diagram of an over-the-air data structure of an updated program guide portion, a UGC item, and an associated content item tag;

FIG. 4 depicts a diagram of a mobile communication device that provides an exemplary GUI for interacting with personalized user-generated content;

FIG. 5 depicts a block diagram of a mobile network for broadcasting;

FIG. 6 depicts a block diagram of an exemplary communication network that comprises one aspect of a transport system that operates to create and transport multimedia content flows across data networks;

FIG. 7 depicts a block diagram of a content provider server suitable for use in one aspect of the content delivery system of FIG. 6;

FIG. 8 depicts a block diagram of a content server (CS) or device suitable for use in one aspect of the content delivery system of FIG. 6;

FIG. 9 depicts a block diagram of an illustrative mobile communication device that is capable of personalized UGC downloading (“clipping”), caching, interaction, tracking and reporting;

FIG. 10 depicts a block diagram of a network apparatus for facilitating personalized broadcast of user-generated content; and

FIG. 11 depicts a block diagram of a user apparatus (e.g., mobile communication device) for personalized reception of a broadcast of user-generated content.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long- range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The term “unicast” refers to the transmission of data, such as packets, to a single address (typically comprising a single device). Generally, unicast networks facilitate two way transmission of point to point data. While such transmissions may be received by multiple pieces of devices, only the addressed device digests the data. Physically, the data is only directed only over those links in a network required to achieve delivery, thereby limiting the number of devices on the network that actually receive the messages to a minimum. Unicast allows a single user to receive personalize data. Web browsing to a particular streamed media clip is an example of unicasting.

The term “multicast” refers to transmitting data to a range of addresses (typically comprising a subset of possible receiving devices). Multicast is typically implemented on an otherwise unicast-based network using network addressing methods for the delivery of information to a group of destinations simultaneously. Multicast methods strive for efficiency through delivering the messages over each link of the network only once, creating copies only when the links to the multiple destinations split, typically at network switches and routers. Multicast is often used for streaming media and Internet television applications where the media is streamed to all requesting users in the same time frame.

The term “broadcast” refers to transmitting data, which may or may not be packetized, to all devices capable of receiving the transmission without reference to an address of the device. Generally, broadcast networks facilitate the one way transmission of date to multiple devices. Classic examples of broadcast are over-the-air television and radio networks. Broadcast networks enjoy power and efficiency advantages over unicast networks in that content need only be sent once for multiple viewers. In contrast, in a unicast network, content must be redundantly sent to everyone who wants to view it, and of course this means inefficient use of bandwidth. If the content is large by nature (like video), the effect is compounded. However, this advantage comes at the cost of personalization—users are typically not able to select content and transmission time in a broadcast network.

One area that has received significant industry attention is distribution of User-generated Content (UGC). Generation of and access to UGC is extremely popular on unicast based systems such as the Internet as illustrated by the popularity of sites such as MYSPACE, FACEBOOK, and YOUTUBE. UGC is generally quite diverse in subject matter and corresponding end user appeal. Access to UGC on these sites is quite personal, in that a user only views that content that they select. Delivery of the clips is initiated by the users selection of the content on the web sites. As such, broadcast distribution of UGC has not been viewed as viable, given that broadcast content and timing is generally centrally controlled and is the same for all subscribers to a broadcast network.

Mobile digital broadcasting services such as the MediaFLO™ broadcast system provided by QUALCOMM CORPORATION®, San Diego, Calif., distribute digital programming to mobile receivers using a broadcasting paradigm. The MediaFLO broadcast system is especially suited for use on mobile communication devices, such as cell phones. As such the MediaFLO broadcast system can provide a second communication channel in the form of a 3G link. This 3G link facilitates the transmission of data in both a forward direction (to the mobile device) and the reverse direction (to a server).

One use of the 3G link is to facilitate a subscription paradigm in which a user must receive a key to decrypt broadcast data prior to viewing multimedia content contained within the data. In this manner, systems like the MediaFLO broadcast system provide a unicast or multicast like experience in which a user selects packages of programming to which they wish to subscribe. Not every user is forced to accept the same programming.

Embodiments described herein facilitate the mimicking of additional functionality generally only found on multicast and unicast systems. For example, embodiments are described that making it appear to a user that he is receiving content broadcast just for him at a time of his or her choosing, even though in reality the content that has been previously recorded. Such content may preferably be UGC, but the embodiment and invention are not so limited in that the content may comprise anything to which a user wishes to subscribe, including multimedia content, general data, or even applications. In particular, described is a mobile broadcast system that supports creation of a personalized broadcast channel through the selective clipping and caching based on, for example, content descriptors of popularity and freshness.

‘Popularity’ can be expressed as an aggregate rating score of the affiliated content item provided by other viewers, or by a count of recorded views of that content item. A “popularity” filter may be constructed that represents usage/rating related information obtained from various sources. For example, these may represent a) rating data provided directly by the content provider, b) usage statistics measured for the mobile broadcast service itself (e.g. Verizon Wireless) via user feedback derived from service interaction), c) a mixture of the above two metrics, or d) some other source and criteria. Furthermore, popularity ratings may either be “flat” or “sorted”. The former category corresponds to rating information collected from all reviewers without distinction. The latter represents ratings provided by reviewers categorized as belonging to specific “domains”, which are classified by metrics such as demographics, user preferences, affinity groups, professional affiliations, etc. Professional reviewer rating information, can be applicable to “regular” content, such as movies, TV programs, etc. Such a popularity filter can be used to determine whether the associated content item should be downloaded (“clipped”) for subsequent accessibility by a user, enhancing filtering based upon user profile and genre. Popularity can also be used as weighting to sort a display of cached content items.

Freshness' indicates how long ago such content item has been made available for broadcast distribution. The terminal may use the metadata contained in these filters, possibly in conjunction with other (E)SG data, and based on stored user preferences/user profiles, decide whether or not to acquire (download and cache) a particular clip. The user, when launching the clip cast service of his/her subscribed mobile broadcast service, sees a listing of available clips for rendering. He/she can subsequently choose the desired clip(s) for presentation. In addition, this innovation presents a means for presentation to the user, a display list of the available cached content items of the same type, in which the order of the content items are weighted by popularity.

An (Electronic) Service Guide or (E)SG may be enhanced to provide support for acquisition and display of broadcast distribution of the personalized UGC and other file content. Metadata associated with the program content (content description, targeted user profile, targeted user location, etc.) can be made available to enable personalized reception of an otherwise diverse and non-targeted content delivery channel. Specifically, for clip cast delivery of UGC clips, filter metadata in the form of “popularity” and “freshness” can be used in the creation of a personalized (E)SG. The terminal may use the metadata, possibly in conjunction with other (E)SG data, and in accordance to stored user preference/user profile information, decide whether or not to acquire a particular clip. The user, when launching the UGC “channel” of his/her subscribed mobile broadcast service, sees a listing of available clips for rendering, and can choose the desired clip(s) for rendering. In the case of broadcast UGC content, the resulting personalized UGC cache can be regarded as a virtual UGC channel tailored to the end user's interests and preferences. As such, it might enhance the appeal and feasibility of UGC delivery as a mobile broadcast service. Again, although the innovation seems particularly useful for filtering broadcast UGC, it is applicable to generalized broadcast content delivery in the creation of a dynamic, personalized content library. Furthermore, this innovation presents a means for presentation to the user, a display list of the available cached content items of the same type, in which the order of the content items are weighted by popularity.

Although this description focuses on personalizing UGC content delivered through broadcast distribution, the methods apply to general file content, such as movie or TV program clips, delivered over over clip cast service. For the clip cast service (called “cachecast” in OMA BCAST), filter metadata in the form of “popularity” and “freshness” can be added to the (Electronic) Service Guide or (E)SG in the creation of a personalized content cache on the terminal. Examples of well-known industry specifications of (E)SGs are the OMA BCAST Service Guide, the DVB IPDC Electronic Service Guide, and the FLO Forum System Information (SI).

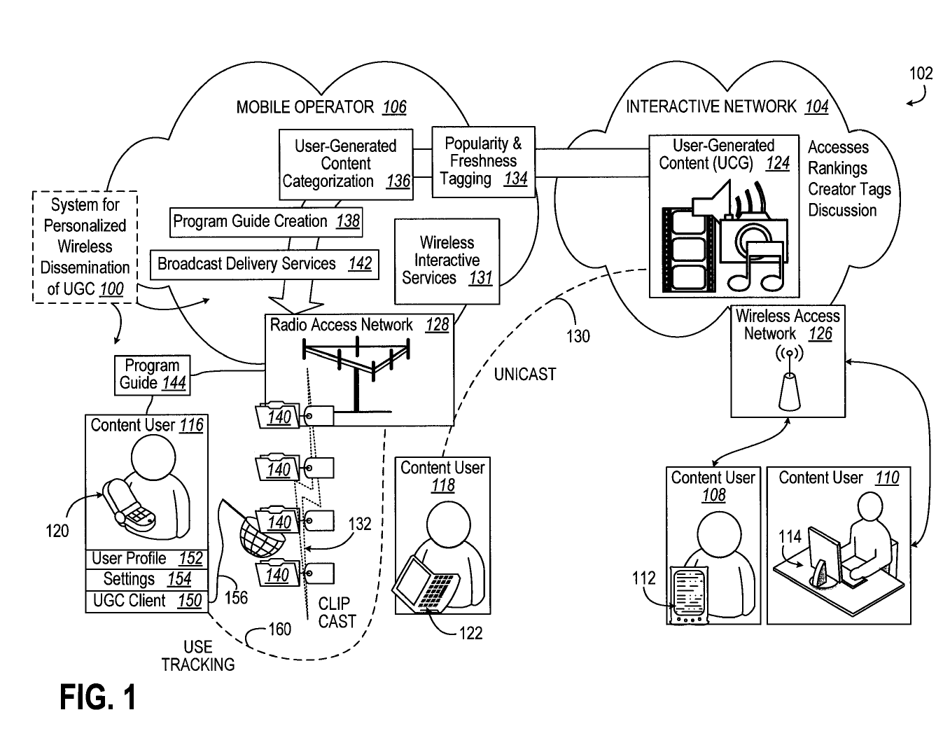

Turning to the Drawings, in FIG. 1, a system 100 for personalized wireless dissemination of user-generated content (UGC) operates across a communication network 102 that encompasses an interactive network 104 and a mobile operator network 106. The interactive network 104 can be substantially or wholly outside of the mobile operator network 106, for example comprising a large terrestrially-based private or public data packet communication network serving content users 108, 110 of computing devices 112, 114. Alternatively or in addition, content users 116, 118 of fixed or mobile communication devices 120, 122 respectively can perform over-the-air two-way data communication with the interactive network 104 via the mobile operator network 106.

A content user 108, 110 can upload user-generated content (UGC) items 124, such as via a wired or wireless access network (WAN) 126 and a content user 116, 118 can upload UGC items 124 via a radio access network (RAN) 128. Other content users 108, 110, 116, 118 can access, download, interact with, post discussion entries about, provide a rating, etc., that give indications about the popularity of particularity UGC items 124. For example, the content user 116, 118 can utilize their respective communication devices 120, 122 via a unicast communication channel 130 supported by a wireless interactive services component 131.

While the UGC items 124 can have useful meta-data associated with it that is provided by the creating content user 108, such meta-data can have wide variance in accuracy or conformance to any standard. Moreover, such content users 108 can have an incentive to inflate the meta-data to enhance the likelihood of being viewed by other content users 110, 116, 118. In order to more objectively and accurately characterize UGC items 124 for determination of a user's interest in downloading by broadcast channel 132, system 100 has a popularity and freshness tagging component 134 that can associate each UGC item 124 with objectively discernable attributes. In addition, a UGC categorization component 136 can associate and tag the UGC item 124 with other genre and type attributes that pertain to the nature of the UGC item 124 directly or pertain to a demographic group that would tend to be interested in such content.

Based upon the available UGC items 124, a program guide creation component 138 can select a sequence of UGC items 140 for distributing by a broadcast delivery services component 142 over the broadcasting channel 132 transmitted by the RAN 128. In one aspect, this sequence is described in a schedule of a distributed program guide 144 received by the communication device 120. A UGC client 150 executed by the device 120 receives and facilitates establishment of a user profile 152 and user settings 154 that provide guidance for selective reception (“clip casting”) of respective ones of the sequence of UGC items 140. Thereby, a communication device 120 with constrained available cache storage, portable power, or processing capacity can judiciously select UGC items 140, depicted at 156. The user 116 subsequently can interact with the cached clips via a graphical user interface (GUI) 158. The system 100 can refine its popularity assessment by receiving use tracking, depicted at 160, from communication device 120 via the RAN 128 and wireless interactive services component 131.

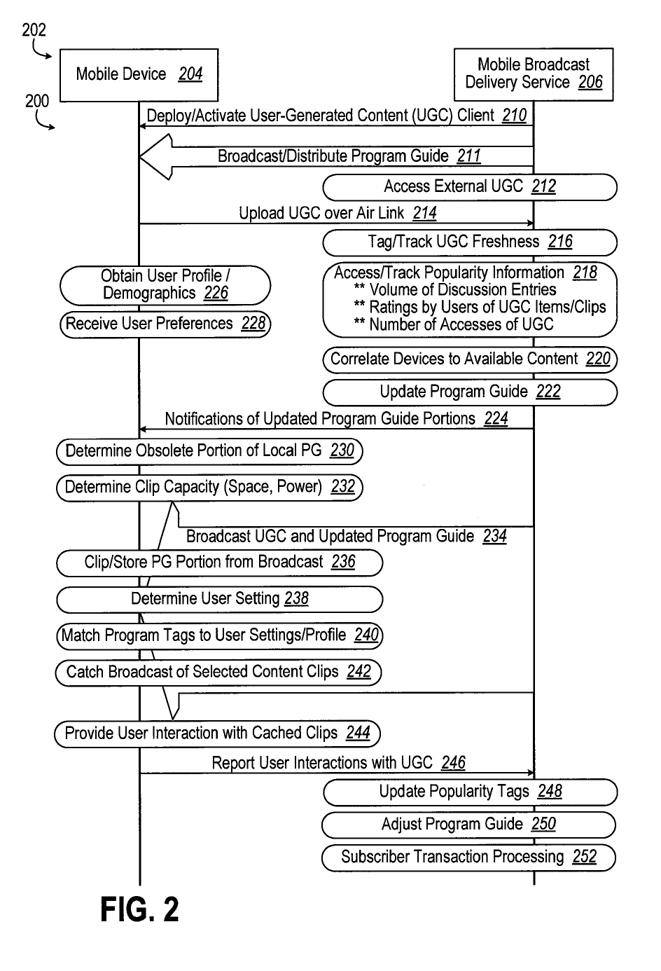

In FIG. 2, a methodology 200 for personalized wireless dissemination of user-generated content (UGC) is depicted as being performed between a communication network 202 of a mobile device 204 and a mobile broadcast delivery service 206. As depicted at 210, a UGC client is deployed, installed or activated on the mobile device 204. The mobile device 204 receives a program guide as depicted at 211. The mobile broadcast delivery service 206 accesses UGC items from external sources (block 212). As depicted at 214, UCG items can also be received over-the-air (OTA) from internal sources. The service 206 tags and tracks the freshness of these UGC items (block 216). The service 206 accesses and tracks popularity of the UGC items (block 218). In an illustrative aspect, this popularity is determined by some combination of factors such as volume of discussion entries associated with the UGC items, rating by users of the UGC items, and a number of accesses, downloads, or interactions with the UGC items.

The service 206 can prioritize available UGC items for broadcast. For instance, characteristics of the population of devices can be correlated to available content with more appropriate (i.e., highly correlated) being given priority (block 220). In an illustrative aspect, priority can be given to more popular or fresher UGC items, especially for predominant demographics for a population serviced by the service 206. Priority can be adjusted by tracking of those who have had an opportunity previously to receive the UGC item or that have actually received the UGC item or similar content. The program guide is updated to reflect the scheduling per this prioritization (block 222). Notifications of such updates are sent from the service 206 to the mobile device 204 as depicted at 224.

The mobile device 204 prepares for selecting UGC items (“clips”) by obtaining a user profile and applicable demographic classifications (e.g., current location, residential location, age, sex, organizational affiliations, etc.) (block 226). The user can provide user preferences for what types of UGC items are of interest (block 228). For example, the user may only want a certain cutoff on freshness or popularity. Further, the user can block certain categories of content, etc.

After receiving the notifications of the updates to the program guide, the mobile device 204 can determine having a locally stored obsolete portion of the program guide (block 230). For example, the stored version of the program guide can include a portion for a time already passed. By deleting this portion, storage space can be made available to download a future portion of the guide. The mobile device 204 can further determine constraints (“clip capacity”), such as portable power and storage space (block 232).

However the program guide is obtained (e.g., unicast, downloaded from the broadcast, etc.), upcoming clips that are deemed appropriate for the user are selected for being captured upon a scheduled future broadcast. Since user-generated content often lacks a degree professionalism in its creation and in its characterization by its creator, the communication device benefits from characterization by the mobile service, in particular popularity and freshness. The advance notice of what is to be broadcast allows the mobile device to determine its needs for additional UGC clips in advance and to still benefit from power savings and reduced processing demands in not having to monitor a UGC channel continually.

Thus, in accordance with the notification of the updated program guide, a sequence of UGC items and updated portions of the program guide are broadcast OTA from the service 206 to the mobile device 204 (block 234). The mobile device 206 in turn selects certain clips for reception, beginning by scheduling to wake up and receive an updated portion of the program guide (block 236). A determination of the user setting is made as they pertain to the scheduled broadcast of UGC items (block 238). Program tags of these scheduled UGC items are matched to user settings and profile (block 240). Responsive to matches/prioritization, selected UGC items are received from the broadcast (block 242). Subsequently, the mobile device 204 affords an opportunity for the user to interact with cached clips (UGC items) (block 244).

User interactions, which can include failing to avail themselves of repeated offerings of a particular UGC item, are tracked and reported to the service as depicted at 236. The service 206 can update the popularity tags of particular UGC items based upon these reports from the mobile device 204 (block 248). The service 206 reprioritizes subsequent rebroadcasts based upon the updated popularity tags (block 250). The usage of the UGC items can also provide a basis for subscriber transaction processing, such as noting whether a user has exceeded certain subscription thresholds for UGC item use (block 252).

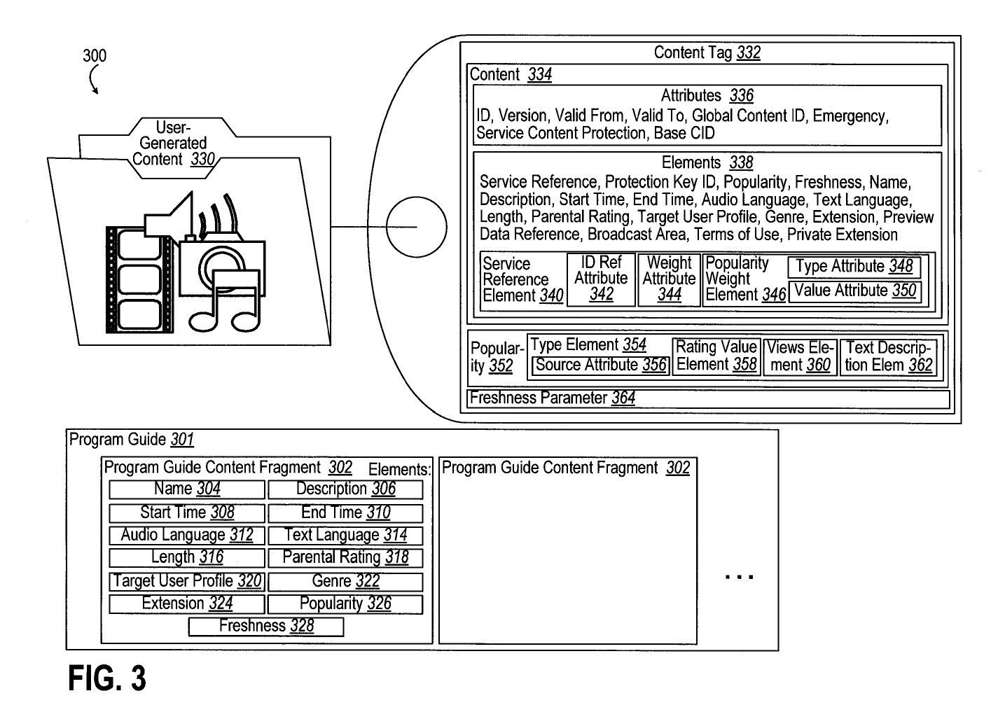

In FIG. 3, a broadcast segment 300 can comprise a program guide 301 sent in its entirety or sent sequentially as a plurality of program guide content fragments 302 having elements of a clip name 304, description 306, start time 308, end time 310, audio language 312, text language 314, length 316, parental rating 318, target user profile 320, genre 322, extension (e.g., file type) 324, popularity 326 (which can be dissected by particular demographic segments), and freshness 328. The program guide elements can be for user interpretation enabling a content creator to provide user readable information about the service. A mobile device can use these guide elements for selecting UGC items for downloading, caching, and presentation to a user as well as providing characterizations useful for sorting and searching. For example, the user may choose to provide settings based on these elements for prospectively downloading or for retroactively sorting and searching.

The segment 300 can also include a UGC item 330 associated with a content item tag 332 having a content item 334 with attributes 336 of ID, version, valid from, valid to, global content ID, emergency, service content protection, and base CID. The content item 334 has elements 338 of service reference, protection key ID, popularity, freshness, name, description, start time, end time, audio language, text language, length, parental rating, target user profile, genre, extension, preview data reference, broadcast area, terms of use, and private extension.

In one aspect, a service reference element 340 can be used to ordering of displays of this content item 334 relative to other content items belonging to the same service as presented to the content user. To that end, the service reference element 340 has an ID reference attribute 342, a weight attribute 344, and a popularity weight element 346 having a type 348 and a value attribute 350. This illustrative data structure provides a weight attribute that can be used to order display/presentation of a specific content item relative to other content items.

The content item tag 332 can comprise a popularity element 352 having a type element 354, which has a source attribute 356, a rating value element 358, views element 360, and a text description element 362. This data structure can facilitate a “popularity rating” representing filter criteria for a mobile device or terminal to decide whether the associated content item should be downloaded and cached for subsequent accessibility by the user. Such filtering, including information such as rating scores or number of views, can complement existing filters such as targeted user profile and genre and can be useful in filtering content delivered over a broadcast UGC clip cast channel for creation of personalized UGC cache. The popularity filtering can represent information obtained directly from the content provider, usage statistics measured by a mobile broadcast service itself, or a combination thereof. Popularity ratings can be flat or sorted. Flat pertains to raw rating information collected from all viewers and sorted dissects this information for certain classifications of users. For example, sorted ratings can be classified by metrics such as demographics, user preferences, affinity groups, professional affiliations, etc. Popularity can encompass professional reviewer rating information.

The content item tag 332 can further comprise a freshness parameter 364 that represents how recently the associated content item was made available for download by the broadcast service provider and could be used for filtering purposes.

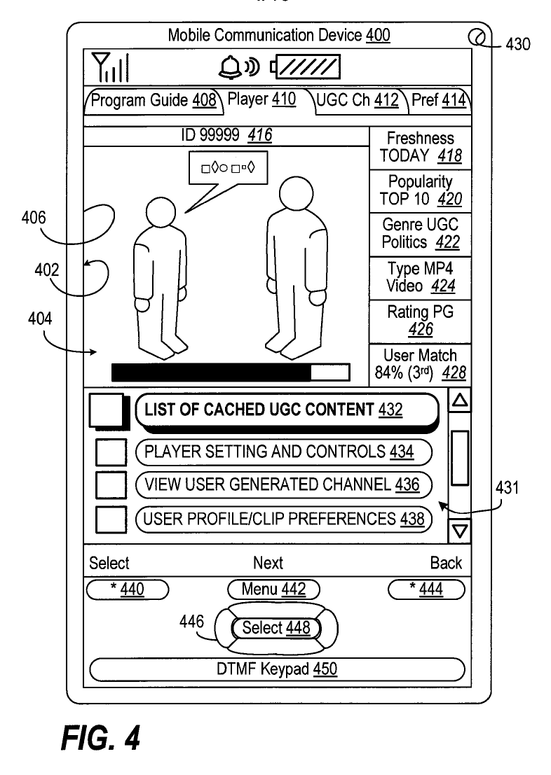

In FIG. 4, a mobile communication device 400 provides an exemplary GUI 402 for interacting with personalized user-generated content.404. An output device is depicted as a graphical display 406 that presents a program guide tab 408, a content player tab 410, a UGC clip cast channel browser tab 412, and a preference tab 414. The graphical display 406 also renders a UGC item as depicted at 416. In some aspects, attributes of the rendered UGC item 416 are displayed, such as a freshness attribute “Today” 418, a popularity attribute “Top 10” 420, a genre of “UGC Politics” 422, a type attribute “MP4 Video” 424, a rating attribute of “PG” 426, and a user correlation match “84%” 428. It should be appreciated that the GUI 402 may further include an audible output 430 and can further include a haptic output (not shown).

The GUI 402 may further include an input device, such as a touch screen portion 431 of the display 406 that may depict other features, such as a list of cached UGC content option 432 that is highlighted, a player setting and control option 434, a viewer user-generated channel option 436, and a user profile/clip preference option 438. In the illustrative depiction, physical input buttons are also provided, which may include but are not limited to a left select button 440, a center menu select button 442, a right back select button 444, cursor keys 446, select key 448, and a dial tone multifunction (DTMF) keypad 450.

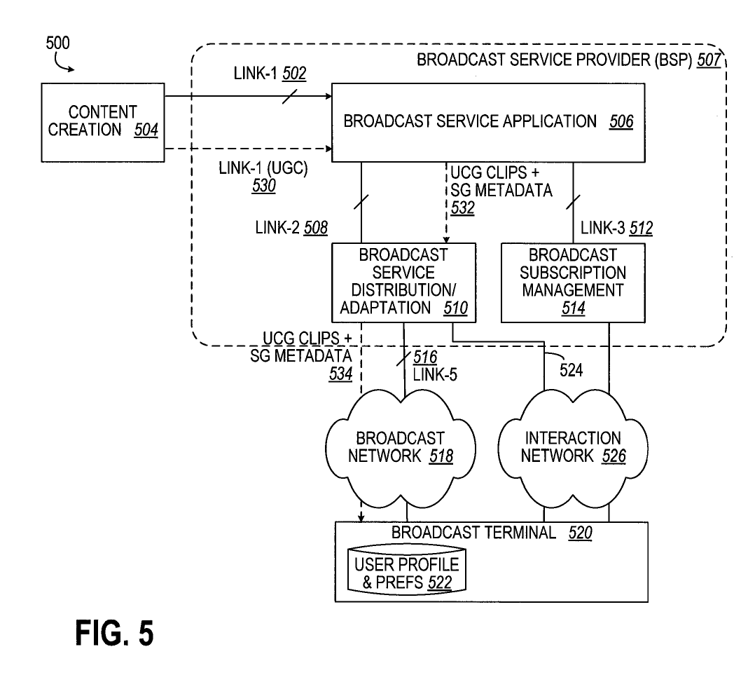

In FIG. 5, a mobile network 500 for broadcasting provides a link-1 interface 502 to transmit institutionally created content from a content creation component 504 to a broadcast service application 506 of a broadcast service provider 507. A link-2 interface 508 passes content from the application 506 to a broadcast service distribution/adaptation component 510. A link-3 interface 512 passes information about the content from the application 506 to a broadcast subscription management component 514. The content adapted for broadcast is transmitted by the distribution/adaptation component 510 via link-5 interface 516 to broadcast network 518 for over-the-air (OTA) transport to a broadcast-receiving terminal 520. The broadcast-receiving terminal 520 can selectively receive and cache such content in accordance with a user profile and preferences data structure 522. Information about this broadcasting is made available to an interaction network 526 for certain interactions with broadcast-receiving terminals 520. The broadcast subscription management component 514 can also provide information regarding receipt of broadcast via the interaction network 526 (e.g., acceptance of terms, return of decryption keys, etc.) to the broadcast terminal 520.

Advantageously, the mobile network 500 can facilitate one-to-many distribution of user-generated content (UGC) from the content creation component 504 via a link-1 (UGC) interface 530 to the broadcast service application 506, which in turn passes UCG clips and program or service guide (SG) metadata as depicted at 532 to the distribution/adaptation component 510, which in turn passes UCG clips and SG metadata as depicted at 534 across the broadcast network 518 to the broadcast-receiving terminal 520.

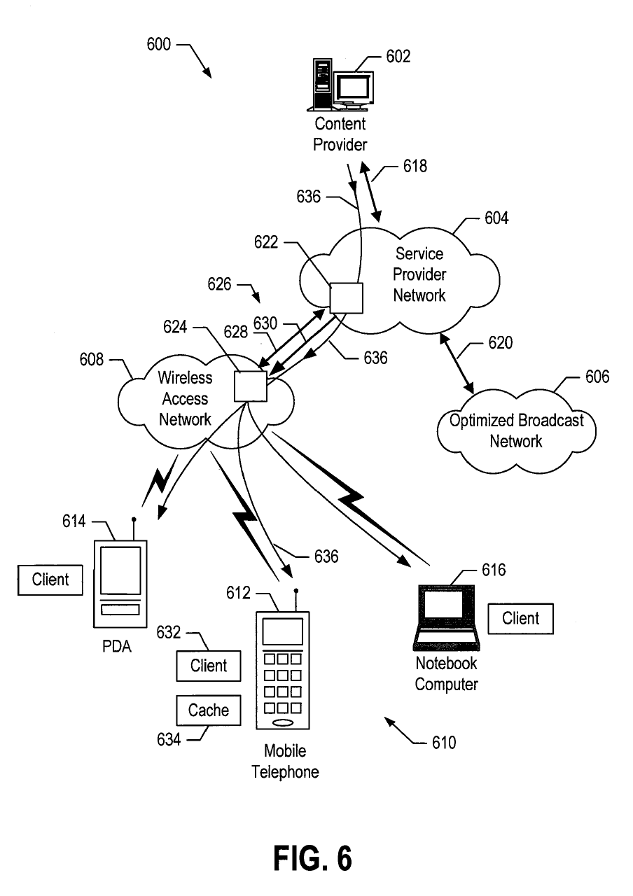

FIG. 6 depicts an exemplary communication network 600 that comprises one aspect of a transport system that operates to create and transport multimedia content flows across data networks. For example, the transport system is suitable for use in transporting content clips from a content provider network to a wireless access network for broadcast distribution.

The network 600 comprises a content provider (CP) 602, a service provider network 604, an optimized broadcast network 606, and a wireless access network 608. The network 600 also includes devices 610 that comprise a mobile telephone 612, a personal digital assistance (PDA) 614, and a notebook computer 616. The devices 610 illustrate just some of the devices that are suitable for use in one or more aspects of the transport system. It should be noted that although three devices are shown in FIG. 6, virtually any number of devices or types of devices are suitable for use in the transport system.

The content provider 602 operates to provide content for distribution to users in the network 600. The content comprises video, audio, multimedia content, clips, real-time and non real-time content, scripts, programs, data or any other type of suitable content. The content provider 602 provides the content to the content provider network 604 for distribution. For example the content provider 602 communicates with the service provider network 604 via the communication link 618, which comprises any suitable type of wired and/or wireless communication link.

The service provider network 604 comprises any combination of wired and wireless networks that operate to distribute content for delivery to users. The service provider network 604 communicates with the optimized broadcast network 606 via the link 620. The link 620 comprises any suitable type of wired and/or wireless communication link. The optimized broadcast network 606 comprises any combination of wired and wireless networks that are designed to broadcast high quality content. For example, the optimized broadcast network 606 may be a specialized proprietary network that has been optimized to deliver high quality content to selected devices over a plurality of optimized communication channels.

In one or more aspects, the transport system operates to deliver content from the content provider 602 for distribution to a content server (CS) 622 at the service provider network 604 that operates to communicate with a broadcast base station (BBS) 624 at the wireless access network. The CS 622 and the BBS 624 communicate using one or more aspects of a transport interface 626 that allows the service provider network 604 to deliver content in the form of content flows to the wireless access network 608 for broadcast/multicast to the devices 610. The transport interface 626 comprises a control interface 628 and a bearer channel 630. The control interface 628 operates to allow the CS 622 to add, change, cancel, or otherwise modify contents flows that flow from the service provider network 604 to the wireless access network 608. The bearer channel 630 operates to transport the content flows from the service provider network 604 to the wireless access network 608.

In one aspect, the CS 622 uses the transport interface 626 to schedule a content flow to be transmitted to the BB S 624 for broadcast/multicast over the wireless access network 608. For example, the content flow may comprise a non real-time content clip that was provided by the content provider 602 for distribution using the service provider network 604. In one aspect, the CS 622 operates to negotiate with the BBS 624 to determine one or more parameters associated with the content clip. Once the BBS 624 receives the content clip, it broadcasts/multicasts the content clip over the wireless access network 608 for reception by one or more of the devices 610. Any of the devices 610 may be authorized to receive the content clip and cache it for later viewing by the device user.

For example the device 610 comprises a client program 632 that operates to provide a program guide that displays a listing of content that is scheduled for broadcast over the wireless access network 608. The device user may then select to receive any particular content for rendering in real-time or to be stored in a cache 634 for later viewing. For example the content clip may be scheduled for broadcast during the evening hours, and the device 612 operates to receive the broadcast and cache the content clip in the cache 634 so that the device user may view the clip the next day. Typically, the content is broadcast as part of a subscription service and the receiving device may need to provide a key or otherwise authenticate itself to receive the broadcast.

In one or more aspects, the transport system allows the CS 622 to receive program-guide records, program contents, and other related information from content provider 602. The CS 622 updates and/or creates content for delivery to devices 610.

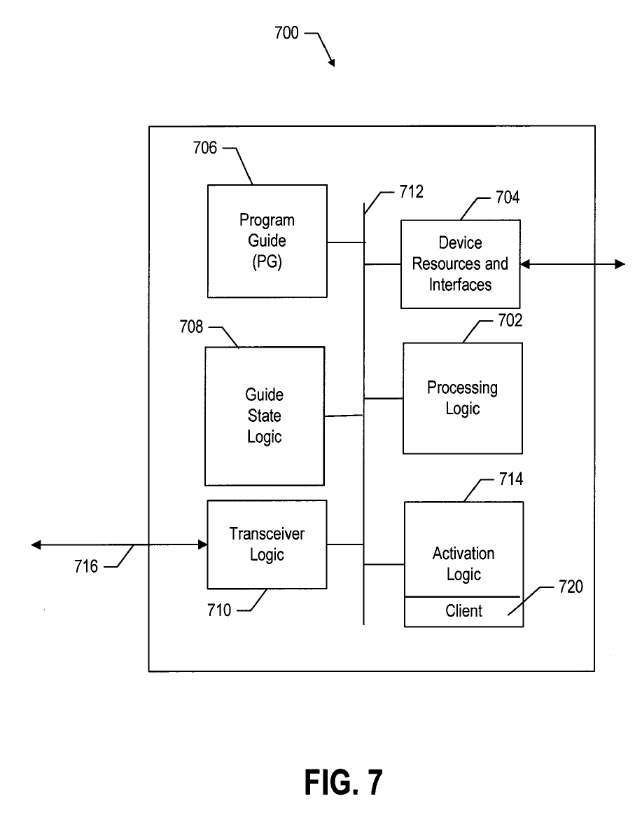

FIG. 7 depicts one aspect of a content provider server 700 suitable for use in one aspect of the content delivery system. For example, the server 700 may be used as the server 602 in FIG. 6. The server 700 comprises processing logic 702, resources and interfaces 704, and transceiver logic 710, all coupled to an internal data bus 712. The server 700 also comprises activation logic 714, PG logic 706, and PG record logic 708, which are also coupled to the data bus 712.

In one or more aspects, the processing logic 702 comprises a CPU, processor, gate array, hardware logic, memory elements, virtual machine, software, and/or any combination of hardware and software. Thus, the processing logic 702 generally comprises logic to execute machine-readable instructions and to control one or more other functional elements of the server 700 via the internal data bus 712.

The resources and interfaces 704 comprise hardware and/or software that allow the server 700 to communicate with internal and external systems. For example, the internal systems may include mass storage systems, memory, display driver, modem, or other internal device resources. The external systems may include user interface devices, printers, disk drives, or other local devices or systems.

The transceiver logic 710 comprises hardware logic and/or software that operate to allow the server 700 to transmit and receive data and/or other information with remote devices or systems using communication channel 716. For example, in one aspect, the communication channel 716 comprises any suitable type of communication link to allow the server 700 to communicate with a data network.

The activation logic 714 comprises a CPU, processor, gate array, hardware logic, memory elements, virtual machine, software, and/or any combination of hardware and software. The activation logic 714 operates to activate a CS and/or a device to allow the CS and/or the device to select and receive content and/or services described in the PG 706. In one aspect, the activation logic 714 transmits a client program 720 to the CS and/or the device during the activation process. The client program 720 runs on the CS and/or the device to receive the PG 706 and display information about available content or services to the device user. Thus, the activation logic 714 operates to authenticate a CS and/or a device, download the client 720, and download the PG 706 for rendering on the device by the client 720.

The PG 706 comprises information in any suitable format that describes content and/or services that are available for devices to receive. For example, the PG 706 may be stored in a local memory of the server 700 and may comprise information such as content or service identifiers, scheduling information, pricing, and/or any other type of relevant information. In one aspect, the PG 706 comprises one or more identifiable sections that are updated by the processing logic 702 as changes are made to the available content or services.

The PG record 708 comprises hardware and/or software that operate to generate notification messages that identify and/or describe changes to the PG 706. For example, when the processing logic 702 updates the PG 706, the PG records logic 708 is notified about the changes. The PG records logic 708 then generates one or more notification messages that are transmitted to CSs, which may have been activated with the server 700, so that these CSs are promptly notified about the changes to the PG 706.

In one aspect, as part of the content delivery notification message, a broadcast indicator is provided that indicates when a section of the PG identified in the message will be broadcast. For example, in one aspect, the broadcast indicator comprises one bit to indicate that the section will be broadcast and a time indicator that indicates when the broadcast will occur. Thus, the CSs and/or the devices wishing to update their local copy of the PG records can listen for the broadcast at the designated time to receive the updated section of the PG records.

In one aspect, the content delivery notification system comprises program instructions stored on a computer-readable media, which when executed by a processor, for instance, the processing logic 702, provides the functions of the server 700 described herein. For example, the program instructions may be loaded into the server 700 from a computer-readable media, such as a floppy disk, CDROM, memory card, FLASH memory device, RAM, ROM, or any other type of memory device or computer-readable media that interfaces to the server 700 through the resources 704. In another aspect, the instructions may be downloaded into the server 700 from an external device or network resource that interfaces to the server 700 through the transceiver logic 710. The program instructions, when executed by the processing logic 702, provide one or more aspects of a guide state notification system as described herein.

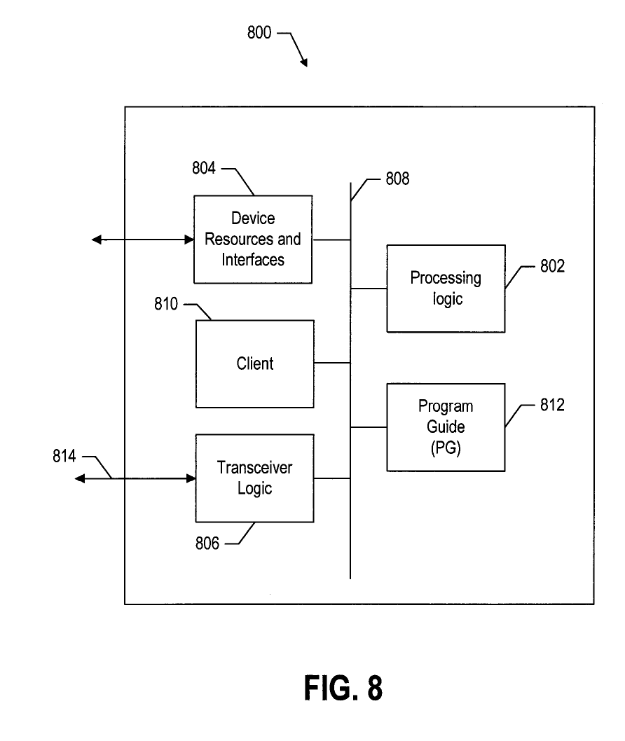

FIG. 8 depicts one aspect of a content server (CS) or device 800 suitable for use in one aspect of a content delivery system. For example, CS 800 may be the CS 622 or the device 110 shown in FIG. 6. The CS 800 comprises processing logic 802, resources and interfaces 804, and transceiver logic 806, all coupled to a data bus 808. The CS 800 also comprises a client 810, and PG logic 812, which are also coupled to the data bus 808.

In one or more aspects, the processing logic 802 comprises a CPU, processor, gate array, hardware logic, memory elements, virtual machine, software, and/or any combination of hardware and software. Thus, the processing logic 802 generally comprises logic configured to execute machine-readable instructions and to control one or more other functional elements of the CS 800 via the internal data bus 808.

The resources and interfaces 804 comprise hardware and/or software that allow the CS 800 to communicate with internal and external systems. For example, internal systems may include mass storage systems, memory, display driver, modem, or other internal device resources. The external systems may include user interface devices, printers, disk drives, or other local devices or systems.

The transceiver logic 806 comprises hardware and/or software that operate to allow the CS 800 to transmit and receive data and/or other information with external devices or systems through communication channel 814. For example the communication channel 814 may comprise a network communication link, a wireless communication link, or any other type of communication link.

During operation, the CS and/or the device 800 is activated so that it may receive available content or services over a data network. For example, in one aspect, the CS and/or the device 800 identifies itself to a content provider server during an activation process. As part of the activation process, the CS and/or the device 800 receives and stores PG records by PG logic 812. The PG 812 contains information that identifies content or services available for the CS 800 to receive. The client 810 operates to render information in the PG logic 812 on the CS and/or the device 800 using the resources and interfaces 804. For example, the client 810 renders information in the PG logic 812 on a display screen that is part of the device. The client 810 also receives user input through the resources and interfaces so that a device user may select content or services.

In one aspect, the CS 800 receives notification messages through the transceiver logic 806. For example, the messages may be broadcast or unicast to the CS 800 and received by the transceiver logic 806. The PG notification messages identify updates to the PG records at the PG logic 812. In one aspect, the client 810 processes the PG notification messages to determine whether the local copy at the PG logic 812 needs to be updated. For example, in one aspect, the notification messages include a section identifier, start time, end time, and version number. The CS 800 operates to compare the information in the PG notification messages to locally stored information at the existing PG logic 812. If the CS 800 determines from the PG notification messages that one or more sections of the local copy at the PG logic 812 needs to be updated, the CS 800 operates to receive the updated sections of the PG in one of several ways. For example, the updated sections of the PG may be broadcasted at a time indicated in the PG notification messages, so that the transceiver logic 806 may receive the broadcasts and pass the updated sections to the CS 800, which in turn updates the local copy at the PG logic 812.

In another aspect, the CS 800 determines which sections of the PG need to be updated based on the received PG update notification messages, and transmits a request to a CP server to obtain the desired updated sections of the PG. For example, the request may be formatted using any suitable format and comprise information such as a requesting CS identifier, section identifier, version number, and/or any other suitable information.

In one aspect, the CS 800 performs one or more of the following functions in one or more aspects of a PG notification system. It should be noted that the following functions might be changed, rearranged, modified, added to, deleted, or otherwise adjusted within the scope of the aspects. (1) The CS is activated for operation with a content provider system to receive content or services. As part of the activation process, a client and PG are transmitted to the CS; (2) One or more PG notification messages are received by the CS and used to determine if one or more sections of the locally stored PG need to be updated; (3) In one aspect, if the CS determines that one or more sections of the locally stored PG need to be updated, the CS listens to a broadcast from the distribution system to obtain the updated sections of the PG that it needs to update its local copy; (4) In another aspect, the CS transmits one or more request messages to the CP to obtain the updated sections of the PG it needs; (5) In response to the request, the CP transmits the updated sections of the PG to the CS; (6) The CS uses the received updated sections of the PG to update its local copy of the PG.

In one aspect, the content delivery system comprises program instructions stored on a computer-readable media, which when executed by a processor, such as the processing logic 802, provides the functions of the content delivery notification system as described herein. For example, instructions may be loaded into the CS 800 from a computer-readable media, such as a floppy disk, CDROM, memory card, FLASH memory device, RAM, ROM, or any other type of memory device or computer-readable media that interfaces to the CS 800 through the resources and interfaces 804. In another aspect, the instructions may be downloaded into the CS 800 from a network resource that interfaces to the CS 800 through the transceiver logic 806. The instructions, when executed by the processing logic 802, provide one or more aspects of a content delivery system as described herein.

It should be noted that the CS 800 represents just one implementation and that other implementations are possible within the scope of the aspects.

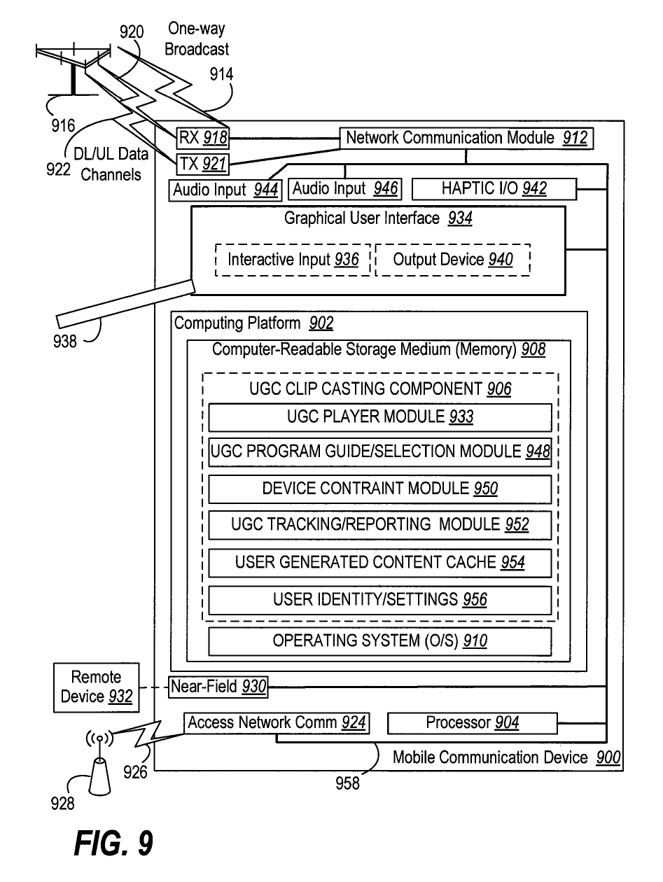

In FIG. 9, an illustrative mobile communication device 900 that is capable of personalized UGC downloading, caching, interaction, tracking and reporting. To that end, a computing platform 902 supports execution by a processor 904 of a UGC clip casting component 906 that resides in computer-readable storage medium (memory) 908 along with an operating system (O/S) 910. A mobile network communication module 912 receives a broadcast channel 914 from a mobile service 916 at a receiver (RX) 918. The receiver 918 also receives a downlink (DL) channel 920 and a transmitter 921 sends an uplink (UL) channel 922 for interactive communications. As example, the network service can be performing third or fourth-generation cellular communication services. Alternatively or in addition, an access network communication module 924 can support over-the-air (OTA) communication channel 926 with a wireless access network 928. Alternatively or in addition, a near-field transceiver 930 can communicate to a remote device 932 as part of personal access network.

The UGC clip casting component 906 can comprise certain modules that enhance user experience with UGC. A UGC player module 933 can support weighted display of available UGC items for selection as well as presenting selected UGC items on a GUI 934, depicted as including an interactive input 936 (e.g., touch screen for a stylus 938) and an output device 940. Alternatively or in addition, a haptic output device 942, an audio input (e.g., microphone) 944, and audio output (e.g., speaker) 946 are provided.

A UGC program guide selection module 948 can support prioritization and selection of UGC items in accordance with a received program guide. A device constraint module 950 can adjust broadcast reception based upon available device storage space, portable power, processing capacity, compatibility of the type of UGC with output capabilities, etc. A UGC tracking and reporting module 952 can enhance subscription services and popularity rating by monitoring user interactions with cached content. A UGC cache 954 provides a structured storage for UGC items. User/device identity and settings 956 provides information for subscription authentication, personalized settings for caching UGC, etc. The various components can be interconnected across a bus 958.

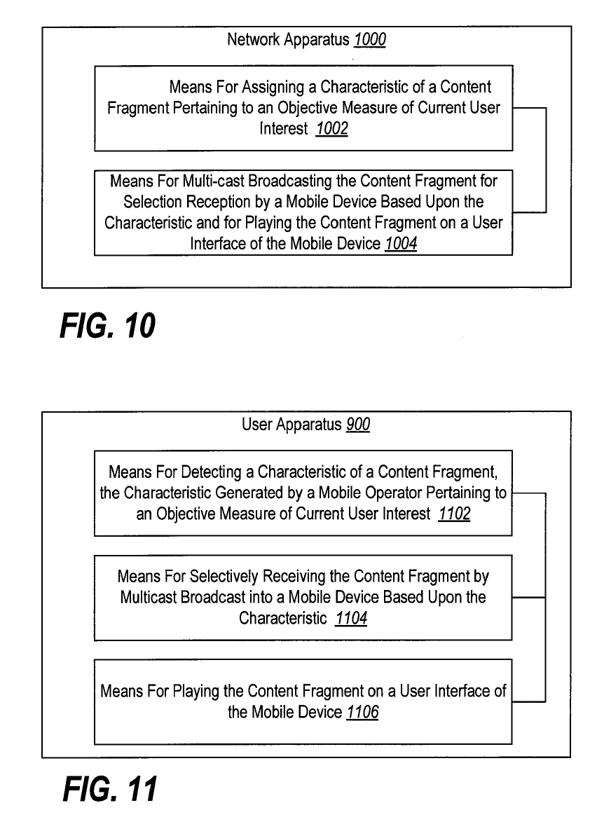

In FIG. 10, a network apparatus 1000 for facilitating personalized broadcast of user-generated content provides means 1002 for assigning a characteristic of a content item pertaining to an objective measure of current user interest and a means 1004 for broadcasting the content item for selective reception by a mobile device based upon the characteristic and for playing the content item on a user interface of the mobile device.

In FIG. 11, a user apparatus (e.g., mobile communication device) 1100 for personalized reception of broadcast of user-generated content comprises means 1102 for detecting a characteristic of a content item, the characteristic generated by a mobile operator pertaining to an objective measure of current user interest. Means 1104 are provided for selectively receiving the content item by broadcast into a mobile device based upon the characteristic. Means 1106 are provided for playing the content item on a user interface of the mobile device.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise. For example, it should be appreciated that benefits of the present innovation can be realized by fixed communication devices and by networks that incorporate communication channels at least in part that are not over-the-air.

What is claimed is:

1. A method for processing user-generated content, the method comprising:
receiving at least one characteristic for each of a plurality of user-generated content items to be broadcast by a mobile operator, the at least one characteristic generated by the mobile operator and pertaining to an objective measure of current user interest in the corresponding user-generated content;
selecting at least one user-generated content item based upon at least one characteristic; and
storing the at least one selected user-generated content item when the selected at least one user-generated-content item is broadcast.

2. The method of claim 1, further comprising uploading user-generated content over a two-way data channel to the mobile operator.

3. The method of claim 1, wherein the at least one characteristic comprises popularity of a user-generated content item.

4. The method of claim 3, wherein the popularity is determined based on a demographic subset of users of the mobile device.

5. The method of claim 3, wherein the popularity is determined based at least in part upon a volume of discussion postings associated with the content item.

6. The method of claim 3, wherein the popularity is determined based at least in part upon a plurality of ratings submitted by users who accessed the content item.

7. The method of claim 3, wherein the popularity is determined based at least in part upon a number of users who accessed the content item.

8. The method of claim 1, wherein the at least one characteristic comprises freshness of a user-generated content item.

9. The method of claim 1, further comprising displaying stored user-generated content items on a user interface of the mobile device sorted by a weighting based on at least one characteristic.

10. The method of claim 9, wherein the at least one characteristic is popularity.

11. The method of claim 9, wherein the at least one characteristic is freshness.

12. The method of claim 1, further comprising:
detecting a category of each of a plurality of user-generated content items;
accessing a category setting for a user of the mobile device; and
wherein the step of selecting user-generated content items is further based on the detected categories and the category setting.

13. The method of claim 1, further comprising:
receiving a program guide for a plurality of content items scheduled for broadcast on a user-generated content channel; and
scheduling to store the selected at least one user-generated content items based upon the program guide.

14. The method of claim 1, further comprising:
tracking user interaction with stored user-generated content items; and
reporting the tracked user interaction to the mobile operator for updating characteristics associated with the stored user-generated content items.

15. A computer product comprising:
a computer-readable storage medium comprising,
a first set of instructions for causing a computer to receive at least one characteristic for each of a plurality of user-generated content items to be broadcast by a mobile operator, the at least one characteristic generated by the mobile operator and pertaining to an objective measure of current user interest in the corresponding user-generated content;
a second set of instructions for causing the computer to select at least one user-generated content item based upon at least one characteristic; and
a third set of instructions for causing the computer to store the at least one selected user-generated content item as the at least one selected user-generated-content item is broadcast.

16. An apparatus for processing user-generated content, the apparatus comprising:
means for receiving at least one characteristic for each of a plurality of user-generated content items to be broadcast by a mobile operator, the at least one characteristic generated by the mobile operator and pertaining to an objective measure of current user interest in the corresponding user-generated content;
means for selecting at least one user-generated content item based upon at least one characteristic;
means for storing the at least one selected user-generated content item as the at least one selected user-generated-content item is broadcast; and
means for playing stored user-generated content items.

17. An apparatus for processing user-generated content, the apparatus comprising:
a communication module detecting at least one characteristic of each of a plurality of user-generated content items, the characteristic generated by a mobile operator pertaining to an objective measure of current user interest;
a receiver receiving a broadcast of user-generated content items;
a storage module selectively storing user-generated content items based on the characteristic; and
a user interface for playing the stored user-generated content items.

18. The apparatus of claim 17, further comprising a transmitter for wirelessly uploading user-generated content to the mobile operator.

19. The apparatus of claim 17, wherein the at least one characteristic comprises a popularity of the user-generated content items.

20. The apparatus of claim 19, wherein the popularity of the user-generated content items are based on a demographic subset of users.

21. The apparatus of claim 19, wherein the popularity of a user-generated content item is based at least in part upon a volume of discussion postings associated with a content item.

22. The apparatus of claim 19, wherein the popularity of a user-generated content item is based at least in part upon a plurality of ratings submitted by users who accessed the content item.

23. The apparatus of claim 19, wherein the popularity of a user-generated content item is based at least in part upon a number of users who accessed the content item.

24. The apparatus of claim 17, wherein the at least one characteristic comprises freshness of a user-generated content item.

25. The apparatus of claim 17, wherein the user interface for displays a list of stored user-generated content items sorted by a weighting based on the characteristic.

26. The apparatus of claim 25, wherein the characteristic comprises popularity.

27. The apparatus of claim 25, wherein the characteristic comprises freshness.

28. The apparatus of claim 17, wherein the storage module further selectively stores user-generated content items based on a category associated with the user-generated content and a user category preference.

29. The apparatus of claim 17, wherein the communication module identifies a time during which the selected user-generated content items are transmitted and activates itself to receive the selected user-generated content based upon the identified time.

30. The apparatus of claim 17, further comprising:
the user interface for tracking user interaction with user-generated content items; and
a transmitter for reporting the tracked user interaction to the mobile operator.

31. A method for broadcasting user-generated content, the method comprising:
assigning at least one characteristic to each of a plurality of user-generated content items, the at least one characteristic pertaining to an objective measure of current user interest in the user-generated content item; and
broadcasting the assigned characteristic and the content item to mobile devices.

32. The method of claim 31, further comprising receiving user-generated content from users.

33. The method of claim 31, wherein the at least one characteristic comprises popularity of the content item.

34. The method of claim 33, wherein the popularity of the content item is based on a demographic subset of users of the mobile device.

35. The method of claim 31, wherein the popularity of the content item is based at least in part upon a volume of discussion postings associated with the content item.

36. The method of claim 33, wherein the popularity of the content item is based at least in part upon a plurality of ratings submitted by users who accessed the content item.

37. The method of claim 33, wherein the popularity of the content item is based at least in part upon a number of users who accessed the content item.

38. The method of claim 31, wherein the at least one characteristic comprises freshness of the content item.

39. The method of claim 31, further comprising scheduling a plurality of content items for broadcasting based on a weighting based of the assigned at least one characteristics.

40. The method of claim 39, wherein the at least one characteristic comprises popularity.

41. The method of claim 39, f wherein the at least one characteristic comprises freshness.

42. The method of claim 31, further comprising:
assigning a category to each of the plurality of user-generated content items; and
transmitting the assigned categories to the mobile device.

43. The method of claim 31, further comprising:
generating a program guide including indications of a plurality of user-generated content items scheduled to broadcast on a user-generated content channel; and
broadcasting the plurality of user-generated content items according to the program guide.

44. The method of claim 31, further comprising:
receiving indications from the mobile device regarding which user-generated content was viewed by a user; and
updating popularity of the content item based on the received indications.

45. A computer product comprising:
a computer-readable storage medium comprising,
a first set of instructions for causing a computer to assign a characteristic to a user-generated content item pertaining to an objective measure of current user interest in the user-generated content item; and
a second set of instructions for causing the computer to broadcast the content item and the assigned characteristic.

46. An apparatus for broadcast of user-generated content, the apparatus comprising:
means for assigning a characteristic to a user-generated content item pertaining to an objective measure of current user interest in the user-generated content item; and
means for broadcasting the content item.

47. An apparatus for broadcast of user-generated content, the apparatus comprising:
a computing platform for assigning at least one characteristic to a plurality of user-generated content items, the at least one characteristic pertaining to an objective measure of current user interest in the user-generated content item; and
a transmitter for broadcasting the user-generated content items and the assigned characteristics.

48. The apparatus of claim 47, further comprising a receiver for receiving user-generated content from users.

49. The apparatus of claim 47, wherein the at least one characteristic comprises a popularity of the content item.

50. The apparatus of claim 49, wherein the popularity is determined based on a demographic subset of users.

51. The apparatus of claim 49, wherein the popularity is determined based a selected one of a group consisting of a volume of discussion postings associated with the content item, a plurality of ratings submitted by users who accessed the content item, and a number of users who accessed the content item.

52. The apparatus of claim 47, wherein the at least one characteristic comprises a freshness of the content item.

53. The apparatus of claim 47, wherein the computing platform schedules a plurality of user-generated content items for broadcasting based on a weighting of assigned characteristics.

54. The apparatus of claim 53, wherein the assigned characteristic used for weighting is popularity.

55. The apparatus of claim 53, wherein the assigned characteristic used for weighting is freshness.

56. The apparatus of claim 47, wherein:
the computing platform assigns a category to each of the plurality of user-generated content items; and
the transmitter transmits the category of the user-generated content items.

57. The apparatus of claim 47, further comprising:
a receiver for receiving user interaction tracking information from the mobile device; and
wherein the computing platform updates the assigned characteristics of the user-generated content items using the user interaction tracking information.
